(19) United States
(12) Patent Application Publication
(10) Pub. No.: US 2002/0106214 A1
(43) Pub. Date: Aug. 8, 2002

(54) Toner supply container and process cartridge

(75) Inventors: Toshiaki Nagashima, Ahiko-shi (JP); Kazuhiko Omata, Toride-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/051,039

(22) Filed: Jan. 22, 2002

(30) Foreign Application Priority Data
Jan. 22, 2001 (JP) 2001-013361

(51) Int. Cl. G03G 15/08

(52) U.S. Cl. 399/106; 399/262

(57) ABSTRACT

A toner supply container detachably mountable to an image forming apparatus, includes a main body, provided with an opening for permitting discharge of the toner, for accommodating the toner; a sealing member for unsealebly sealing the opening; wherein the opening is unsealed by tearing a part of the sealing member, wherein a pattern of welding with which the sealing member is welded on the main body of the container is inclined inwardly with respect to a tearing direction at a laterally outward end portion at a tearing starting side end portion.

### FIELD OF THE INVENTION AND RELATED ART

The present invention relates to a toner supply container for supplying toner into an image forming apparatus of an electrostatic recording type, an electrophotographic type or the like, such as a copying machine, a printer, a facsimile machine or the like, and to a process cartridge detachably mountable to the image forming apparatus.

In an image forming apparatus such as an electrostatic copying machine, printer and the like, powdery toner is used, and is supplied with toner from a toner supply container. The toner supply container generally comprises a cylindrical, rectangular parallelopiped or the like shape main body made of synthetic resin material, and a toner seal member for sealing an opening of the main body provided to permit supply of the powdery toner into a developing device.

More particularly, in an image forming apparatus using an electrophotographic image forming process, a cartridge integrally containing an electrophotographic photosensitive member and developing means actable on the electrophotographic photosensitive member and is detachably mountable to the main assembly of an image forming apparatus (process cartridge type). The process cartridge type is advantageous in that maintenance operations can be performed not by a service person but by the user in effect, and therefore, operation property has been significantly improved. Therefore, the process cartridge type is widely used in the field of image forming apparatus.

A type of process cartridge integrally contains a photosensitive drum, a cleaner, a charger and the like as well as the toner supply container. The developing means provided in the process cartridge integrally comprises a developing member for developing an electrostatic latent image formed on the photosensitive drum with the toner, and a toner supply container for supplying the toner to the developing member.

As for the toner seal member, there are two types in one which one sheet of film is used to steal, and a sealing portion of the film is peeled off upon unsealing (easy peel type), and in the other of which the film is torn. In the type of feeling the film, there are a type image a cover film and a tear tape are integrated, and upon the unsealing, the tear tape is pulled to tear the cover film by the tear tape (tear tape type), a type in which one tearable sealing member is used. They are widely used because of their advantages that unsealing strength (resistance) can be decreased and that width of the opening is controllable. Japanese Laid-open Patent Application Sho 59-13262, Japanese Laid-Open Utility Model Application Sho 63-60164, Japanese Laid-open Patent Application Hei 8-328369, Japanese Laid-open Patent Application Hei 11-72999, for example, the close methods using a single tearable sealing member. Japanese Laid-open Patent Application Hei 11-102105 proposes a sealing member which is treated by a half cutting process using a laser.

The present invention provides for the improvements of these types of sealing member.

The conventional tearable film type involves a problem that balance between the film tearing performance (easy tearing) and the bonding strength of the marginal portion supporting the tearing part. For example, upon the unsealing, the film is not torn because of high unsealing strength (the pulling force required to the free end of the film), or the tearing occurs along unintended lines with a result of wider opening, upon without the toner supply control is not proper after the unsealing, or the sealing member clogs the sealing member pulling opening.

### SUMMARY OF THE INVENTION:

Accordingly, it is a principal object of the present invention to provide a toner supply container and a process cartridge in which a welded portion of the sealing member is prevented from peeling upon the start of the tearing of the sealing member.

It is another object of the present invention to provide a toner supply container and a process cartridge in which the sealing member can be stably torn while the withstand pressure property during the transportation is sufficient.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS:

FIG. 1 is a sectional view illustrating a layer structure of a sealing member used in a toner supply container according to Embodiment 1 of the present invention.

FIG. 2 is a sectional view illustrating a layer structure of the sealing member used in the toner supply container according to Embodiment 1 of the present invention.

FIG. 3 is a sectional view illustrating a layer structure of the sealing member used in the toner supply container according to Embodiment 1 of the present invention.

FIG. 4 is a top plan view of a sealing member used in the toner supply container according to Embodiment 1.

FIG. 5 is a partial enlarged view of the sealing member used in the toner supply container according to Embodiment 1 of the present invention.

FIG. 6 is a perspective view of the toner supply container according to Embodiment 1.

FIG. 7 is a top plan view of a seal pattern of the toner supply container of Embodiment 1.

FIG. 8 is a perspective view of the toner seal in the toner supply container according to Embodiment 1, wherein the toner seal has been unsealed to a certain extent.

FIG. 9 is a perspective view of the toner seal in the toner supply container according to Embodiment 1, wherein the toner seal has been unsealed.

FIG. 10 is a partial enlarged view of the seal portion of the toner supply container according to Embodiment 1.

FIG. 11 is a partial enlarged view of the toner seal of the toner supply container according to Embodiment 1 in the initial stage of unsealing action.

FIG. 12 is a partial enlarged view of the toner seal of the toner supply container according to Embodiment 1 in the initial stage of unsealing action.

FIG. 13 is a partial enlarged view of the seal portion of the toner supply container according to Embodiment 2.

FIG. 14 is a partial enlarged view of the toner seal of the toner supply container according to Embodiment 2 in the initial stage of unsealing action.

FIG. 15 is a top plan view of a sealing member used in the toner supply container according to Embodiment 3.

FIG. 16 is a sectional view illustrating a layer structure of the sealing member used in the toner supply container according to Embodiment 3 of the present invention.

FIG. 17 is a partial enlarged view of the seal portion of the toner supply container according to Embodiment 3.

FIG. 18 is a longitudinal sectional view of a laser beam printer A.

FIG. 19 is a perspective view of an outer appearance of a laser beam printer A.

FIG. 20 is a longitudinal sectional view of a process cartridge B.

FIG. 21 is a partial enlarged view of a seal portion of a toner supply container according to a comparison example 1.

FIG. 22 is a partial enlarged view of the toner seal of the toner supply container according to comparison example 1 in the initial stage of unsealing.

### DESCRIPTION OF THE PREFERRED EMBODIMENTS:

(Embodiment 1)

The description will be made as to a toner seal member 1 for a toner supply container according to Embodiment 1 of the present invention.

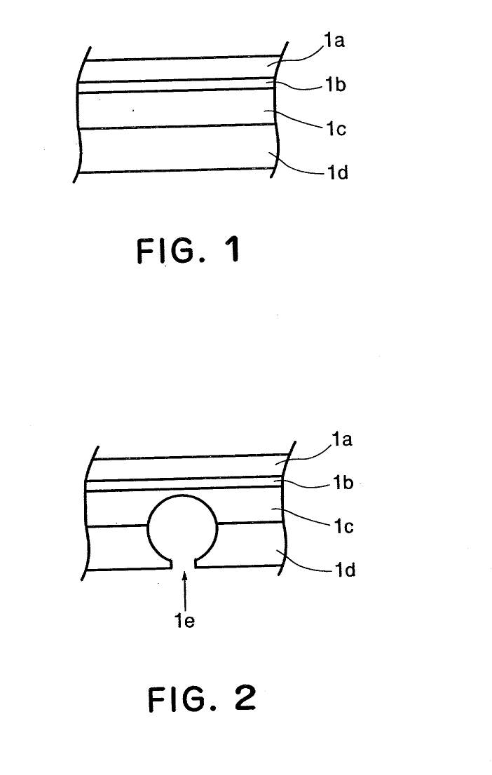

The toner seal member 1 of this embodiment has a 4 layer structure including a surface layer, a laser blocking layer, a tearing guide layer and a sealant layer, in the order named from the top. In this embodiment, the surface layer is made of biaxial orientation polyester film having a thickness of 12 μm; the laser blocking layer is made of an aluminum foil having a thickness of 7 μm; the tearing guide layer is made of biaxial orientation polyester having a thickness of 50 μm; and the sealant layer is made of a copolymer resin material of polyethylene and ethylene and vinylacetate having a thickness of 50 μm. FIG. 1 is a sectional view of the toner seal member 1. It comprises a surface layer 1a, a laser blocking layer 1b, a tearing guide layer 1c and a sealant layer 1d in the order named from the top.

The surface layer 1a is required to have a heat resistive property to permit welding of the toner seal member 1 onto the main body 2 of the toner supply container, and is required to have a sufficient film strength to maintain a sealing performance as a toner seal. In addition, it is also required to have a good tearing property to permit is the tearing for the unsealing. Therefore, the material is preferably biaxial orientation polyester having a thickness of 10-20 μm, preferably 12-17 μm.

The laser blocking layer 1b is required to have a property of not absorbing carbon dioxide laser. It is also required to have a property of preventing the damage of the surface layer by the heat irradiation during the laser machining. Similarly to the surface layer, it is required to have an easy tearing property for the unsettling. Therefore, it is preferably made of aluminum foil having a thickness of 5-15 μm, preferably, 7-12 μm.

The tearing guide layer 1c is required to have a property of assuredly absorbing the carbon dioxide laser to melt and to provide a stable tearing portion. The portion adjacent to the tearing portion is required to have a sufficient strength and the tearing guide. Therefore, it is preferably made of biaxial orientation polyester having a thickness of 40-70 μm, preferably 40-60 μm.

The sealant layer 1d is required to assure a sufficient bonding strength relative to the toner supply container (sealing property!kP), and therefore, it is preferably made of copolymer resin material of polyethylene and ethylene=vinylacetate having a thickness of 40-70 μm, preferably 40-60 μm.

The materials and the thicknesses of the layers of the toner seal member 1 described in the foregoing are not limiting, but may be other materials and thicknesses if the required properties are satisfied.

The tearing guide layer 1c of polyester is mainly melted from the sealant layer of the toner seal member 1 using a carbon dioxide laser to constitute the tearing portion 1e.

FIG. 2 shows a toner seal sectional view for forming the tearing portion. As shown in FIG. 2, the tearing portion 1e is provided below the aluminum foil layer which is a laser blocking layer, more particularly, it is provided in the polyester of the tearing guide layer 1c melted by observing the carbon dioxide laser and in the sealant layer 1d which is melted by the heat irradiation.

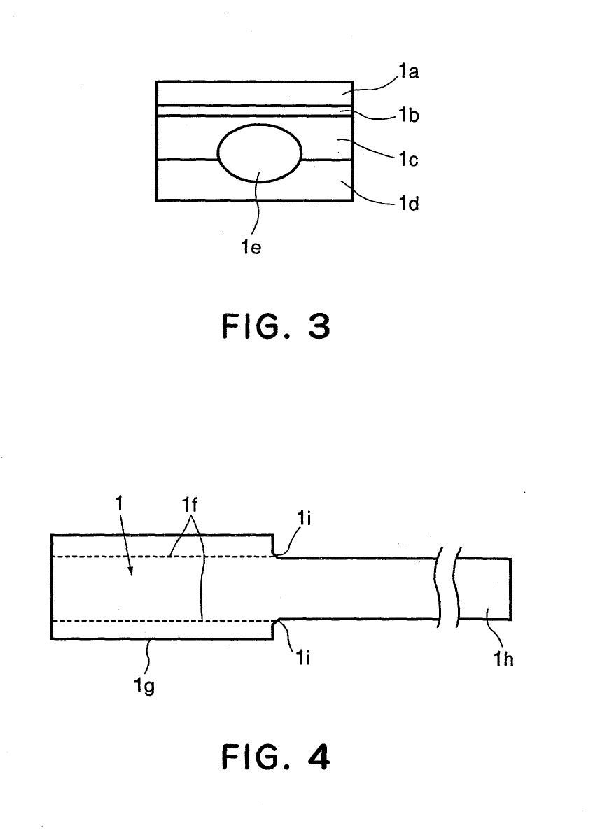

The output of the carbon dioxide laser in this embodiment was 8 W. Depending on the output (W) of the used laser and the material of the sealant, the sealant layer per se would not completely melted with a result that groove is not formed in the tearing portion 1e as shown in FIG. 2, and/or, a gap 1e may be formed between the polyester of the tearing guide layer 1c and the sealant layer 1d as shown in FIG. 3.

The description will be made as to the assembling of the toner seal member 1 and the main assembly 2 of the toner supply container this example.

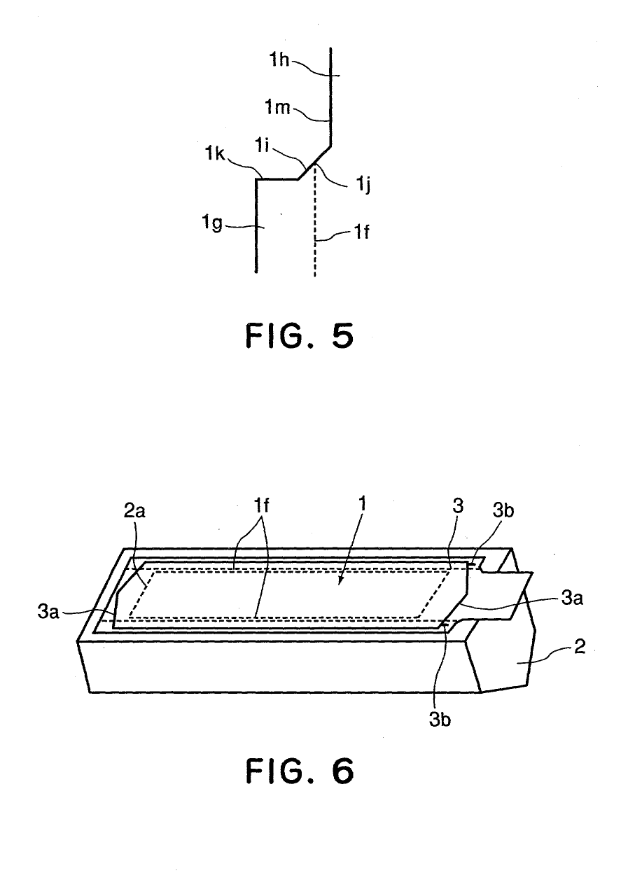

FIG. 4 shows a toner seal member 1 of this embodiment. The toner seal member 1 of this embodiment comprises a sealing portion 1g for sailing a toner discharging opening of the main body 2 of the toner supply container (the region including a welded portion which is welded on the container along the longitudinal direction of the sealing member) and a drawing portion 1h which is extended from the sealing portion 1g and is used to pull the sealing portion 1g upon the unsealing. The drawing portion 1h is not fixed, and therefore, is a free end. As shown in FIG. 5, a connecting portion 11 between the sealing portion 1g and the drawing portion 1h is inclined by 45° relative to the drawing direction, and an edge portion 1j of a linear tearing portion 1e of the tearing portion guide 1f ends at the connecting portion 11.

FIG. 5 is a partial enlarged view of a portion shown in FIG. 4. The edge configuration is defined to permit is the tearing, and the inclined portion may be accurate, for example. The two tearing portion 1f shown in FIG. 4 are disposed such that toner discharging opening 2a of the main assembly 2 of the toner supply container is fully open as shown in FIG. 6 upon unsealing operation. The connecting portion 11 is provided between a longitudinal end edge 1k of the sealing portion 1g and aside edge 1m of the drawing portion 1h.

In this embodiment, the toner seal member 1 is welded on the main body 2 of the toner supply container by heat seal. FIG. 6 shows the toner seal member 1 mounted on the main body 2 of the toner supply container.

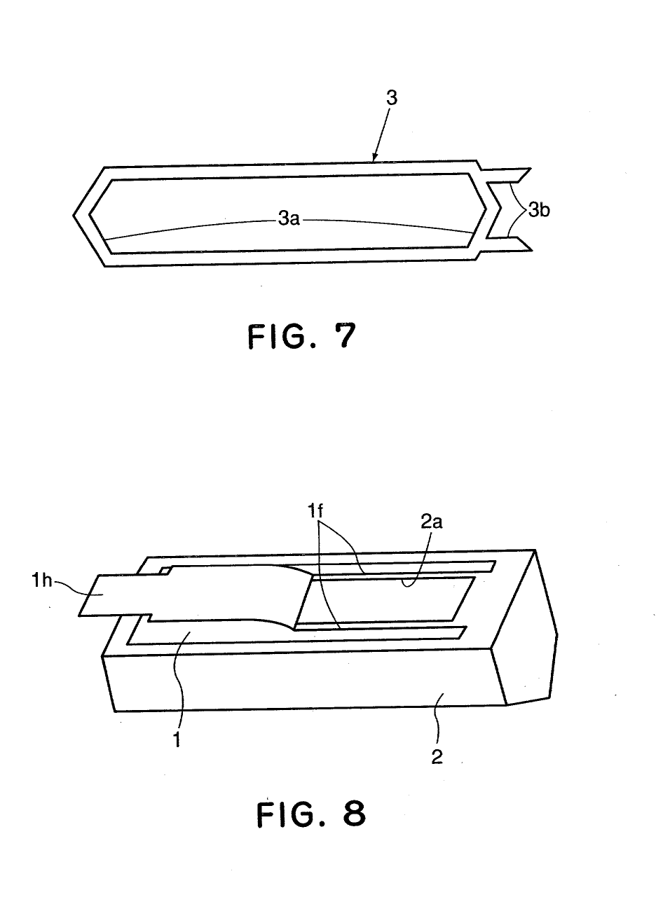

FIG. 7 shows a seal pattern configuration, that is, a welding pattern of the welded portion of the heat seal. The seal portion 3 (welded portion) extends enclosing the toner discharging opening 2a on a plane including the outer edge of the toner discharging opening 2a. The longitudinal end 3a (front and rear ends) of the seal portion 3 is chevron-shaped in order to decrease the strength of the toner seal member 1 upon the unsealing. For a further assurance of the tearing of the toner seal member 1, extended seal portions 3b are provided continued form the longitudinal end 3a at the tear starting side end 3a, by which outer lateral sides of the tearing portion 1f of the toner seal member 1 are confined upon the tearing operation. The longitudinal end 3a of the seal portion 3 may be linear when the width is so short that influence to the unsealing strength is small.

A seal welded portion configuration of a sealing jig is in conformity with the welding pattern corresponding to the seal portion 3.

The sealing conditions are:

Pressure: 0.5 MPa (a cylinder having a diameter of 100 mm):

temperature: 150° C.:

time: 3 sec. The sealing condition are not limiting, but may be properly selected by one skilled in the art depending on the materials of the seals, the material of the main body of the container, the concealing area, the sealing width and the like.

The material of the sealing jig may be any in the heat conduction is high, the process property is satisfactory, and the durability is sufficiently high. More particularly, brass, stainless steel or the like is preferable. In this embodiment, the material was brass.

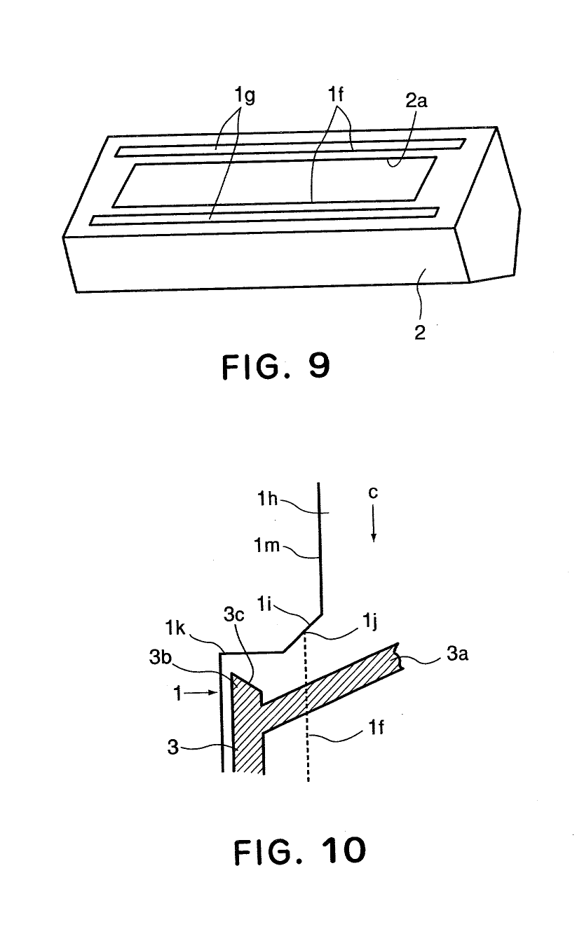

FIGS. 8, 9 show unsealing state of the toner seal member 1 of this embodiment.

The drawing portion 1h which is a free end of the toner seal member 1 is folded back, and is pulled, by which the toner seal member 1 is torn along the tearing portions 1f so that toner discharging opening 2a of the main body 2 of the toner supply container is opened. By doing so, the toner becomes able to be discharged.

FIG. 10 is an enlarged view of an unsealing start portion of the toner seal member 1.

When the toner seal member 1 is opened, the drawing portion 1h of the toner seal member 1 is folded back and is pulled, by which the toner seal member 1 is torn along the tearing portion 1f, as described above. In order to assure the edge portions 1j of the toner seal member 1 to be torn, the seal portions 3b extended out are desirably fixed securely.

More particularly, when the extended seal portion 3b is more securely welded than the tearing strength of the edge portion 1j, the edge portion 1j can be torn without the welded seal portion 3b being peeled off. On the contrary, when the welding strength of the extended seal portion 3b is weaker than the tearing strength of the edge portion 1j, the seal portion 3b is peeled off without the tearing, with the result of increased unsealing strength and incapability of control of the width of the opening.

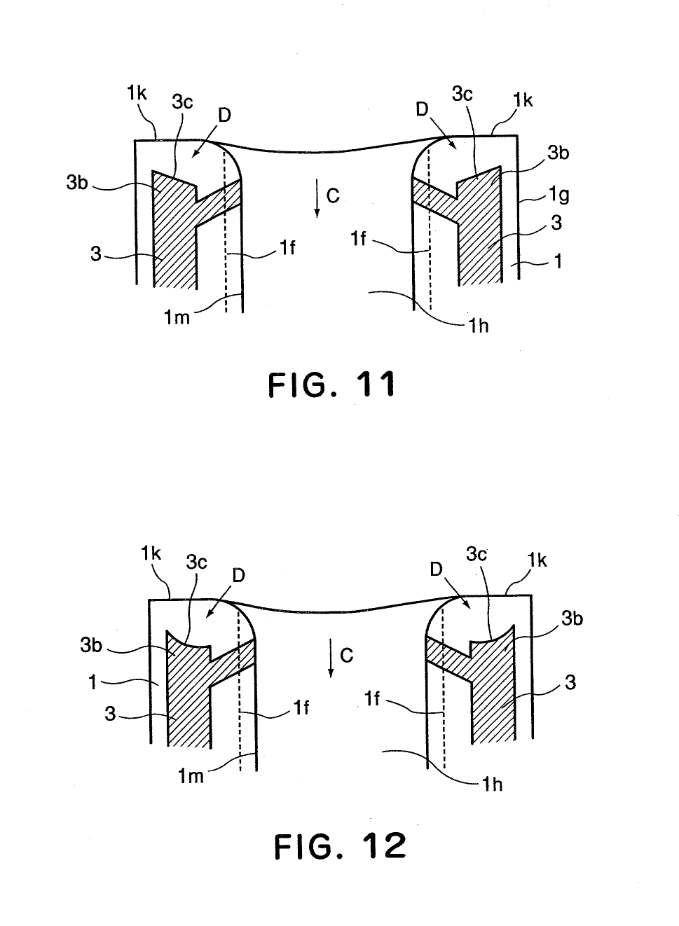

Therefore, the bonding strength of the extended sealing member 3b is important. In this embodiment, there is provided a rectilinear configuration inclined inwardly with respect to the tearing direction C at the extreme end of the extended seal portion 3b (welded portion). More particularly, as shown in FIG. 10, at the end portion of the extended sealing member 3b, rectilinear configuration is provided at an angle of 450 with a message to the unsealing stretching of the toner seal member, and it is not extended beyond the toner seal member 1. FIG. 11 shows a sealing portion in which the drawing portion 1h is folded back at the edge 1k of the sealing portion 1g and overlaid on the sealing portion 1g. As shown in FIG. 11, the rectilinear configurations of the seal portions 3b are both inclined inwardly such that when the drawing portion 1h of the toner seal member 1 is folded back and pulled upon unsealing of the sealing member 1, the force D applied to the extended seal portion 3b in the peeling direction (raising the edge portion 1j) is resisted.

By this arrangement, even if such a force D is produced, the inclined rectilinear configuration is effective to permit the force D to be received at a line, so that bonding strength is sufficient against the force D in the peeling direction. Accordingly, the unintended peeling of the seal portion or the like can be avoided when the toner seal member 1 is torn, thus assuring proper unsealing. In this embodiment, even if positional deviation, particularly in the longitudinal direction (the direction C or the opposite direction in FIG. 10) occurs in the assembling, the force D can be stably received at a line, and therefore, the unsealing property is not influenced, by which the latitude in the assembling is improved.

In this embodiment, the extended seal portion 3b has a width of 2.5 mm, and the angle of 45° of the rectilinear configuration with respect to the unsealing pulling direction C of the toner seal member 1. However, these values are not limiting, and may be changed if the above-described advantages are provided by one skilled in the art depending on the configuration of the toner seal member and the position of the seal pattern.

As shown in FIG. 12, the inclined linear configuration at the end of the extended seal portion 3b may be actuate, more particularly, concave toward the force D in the peeling direction to approximate the raising of the edge portion 1j so that force can be received at the arcuation, so that length of the force receiving portion is increased, and therefore, the force is distributed more widely. This further improves the resistance against the peeling force. In this embodiment, the arcuate configuration is given a radius of 20 mm at the end portion. This is not limiting, and may be changed properly by one skilled in the art as long as the above-described advantageous effects are provided. The concavity may have a configuration other than arcuation, if it is generally concave toward the peeling force. Here, the concavity should be shallow in either case, that is, irrespective of whether the configuration is actuate or not. If the concavity is deep, the intermediate portion of the seal portion 3 cannot properly withstand the peeling force at the end portions of the curve providing the concave configuration. On the contrary, the linear configuration may be convex if the convexity is very small, that is, very close to rectilinear configuration, as long as the abovedescribed advantageous effects can be provided.

In this embodiment, the extended seal portion 3b is not extended beyond the toner seal member 1, but may be extended beyond that, as long as the above-described advantageous effects can be provided. However, when the extended seal portion 3b extends beyond the toner seal member 1, there arises a liability that sealant layer 1d may be contacted to the sealing jig having the same pattern as the seal portion 3. Therefore, additional modification such as the surface of the sealing jig being coated with Teflon layer or cloth for parting property. In this sense, the seal portion 3b is preferably not extended beyond the toner seal member 1.

In this embodiment, the heat seal is used as the welding means. However, the welding means may be another, such as impulse sealing, ultrasonic welding or the like, as long as the above-described advantageous effects are provided.

In this embodiment, the toner seal member 1 is a sealing member machined by laser. However, this is not limiting, and the use can be made with a sealing member which is provided by uniaxial orientation process and which has a good longitudinal clearing property, or the material and the structure may be another sealing member as long as the tearing probably is good.

According to this embodiment, the heat seal is enough to provide the sealing, and therefore, the cost increases can be avoided in the assembling. In addition, the stability of the unsealing property of the toner seal can be improved with a simple structure.

Unsealing test has been carried out with the toner supply container of this embodiment, and it has been confirmed that unsealing strength is stably approx. 2-3 kg f, and tearing occurs at the intended portions. In addition, it has been confirmed that seal portion is not raised or peeled off.

(Embodiment 2)

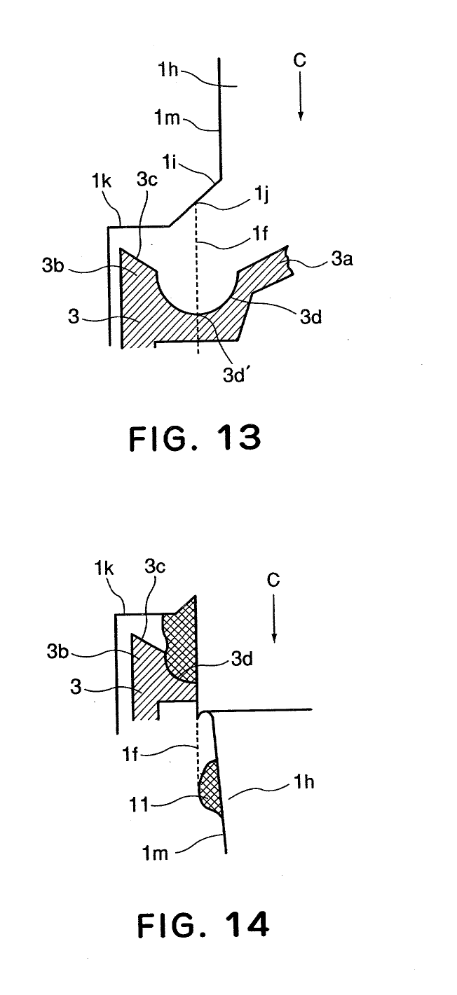

This embodiment is similar to the foregoing embodiment except for the portion of the heat seal pattern which crosses with the tearing portion 1f of the toner seal member 1 has a concave configuration with respect to the unsealing direction C of the toner seal member 1. FIG. 13 shows the sealing member according to this embodiment. This.

As shown in FIG. 13, at the longitudinal end portion 3a of the seal portion 3, there is provided a concave configuration 3a with respect to the unsealing direction C of the seal in the portion crossing with the tearing portion 1f of the toner seal member 1. More particularly, the configuration is arcuate, and the apex 3a is aligned with the tearing portion 1f. Here, the apex of arcuation is a contact point between the arcuation of the concave configuration is contacted with a line perpendicular the pulling direction of the toner seal member.

When the toner seal member 1 is removed, the edge portion 1j tends to be raised, and the peeling force D applied to the rectilinear inclined portion 1j of the extended seal portion 3b is contrasted to the tearing strength of the free end edge 1j. However, the bonding strength (at the line) of the seal portion 3b is sufficiently larger, and therefore, the edge portion 1j is torn, and the unsealing begins. If, at this time, delamination between layers in the toner seal member l or non-torn portion occurred, the tearing portion 1f is torn, because of the provision of the concave configuration of the sealing portion.

The delamination is the phenomenon which occurs when the bonding strength in the toner seal member is not enough, or the laser machining for the tearing portion le is not enough. More particularly, the toner seal member is not torn at all the layers along the intended lines, but peeling occurs at the surface layer side, more particularly, between the surface biaxial orientation polyester layer and the second aluminum foil layer or between the aluminum foil layer and the third biaxial orientation polyester, and the peeling expands. If the peeling occurs in a large scale, the unsealing strength (resistance) increases, or the toner seal member clogs in the pulling opening. In this embodiment, as shown in FIG. 14, even if such a delamination occurs (11 in FIG. 14), the expansion of the delamination is stopped by the concave configuration 3a of the sealing portion, and the tearing line is guided to restore the intended line 1f.

In addition, even if the tearing partly fails, more particularly, the tearing occurs at inside of outside the intended tearing portion 1f, the concave configuration 3a of the seal portion is effective to guide the tearing line to the intended or regular line 1f. In other words, even if the tearing line is deviated upon the unsealing of the toner seal member, the tearing line is guided by the concave configuration 3a of the seal portion to the regular line If. The concave configuration 3a may be any if the above-described advantageous effects are provided. In this embodiment, it is arcuate, but may be V-shaped or trapezoidal configuration.

Unsealing test has been carried out with the toner supply container of this embodiment, and it has been confirmed that unsealing strength is stably approx. 2-3 kg f, and tearing occurs at the intended portions. In addition, it has been confirmed that seal portion is not raised or peeled off.

In order to confirm the latitude in view of the variation in the manufacturing, tests were carried out in which the bonding strength between the biaxial orientation polyester layer (surface layer) and the aluminum foil layer (second layer) and/or between the aluminum foil (second layer) and the biaxial orientation polyester layer (third layer), and unsealing tests were carried out with such samples. It has been confirmed that delaminations are all limited within the recess configuration 3a of the seal portion, and are not expanded. The unsealing strength (resistance) has not increased. Therefore, the latitude in the assembling operation is improved.

(Embodiment 3)

In this embodiment, the toner seal member comprises a cover film 4 for sealing the toner discharging opening 2a and a tear tape 5 lined on the cover film 4 for tearing the cover film 4 with a width substantially equal to the toner discharging opening. This embodiment is similar to Embodiment 1 in other respects.

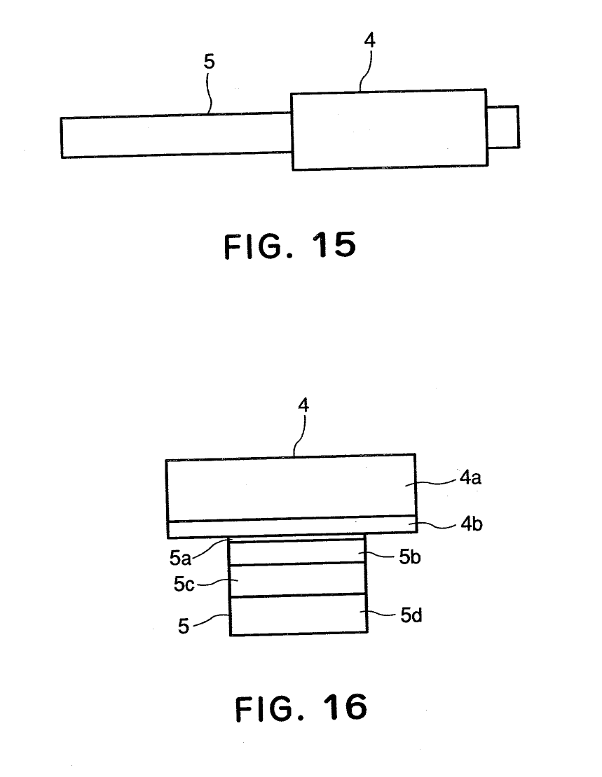

FIGS. 15, 16 show a toner seal member 1 of this embodiment. The cover film 4 sealing the toner discharging opening 2a comprises a layer of expansion bubble generation polypropylene layer (140 μm (4a) and an EVA sealant layer (20 μm (4b)).

The tear tape 5 comprises a polyester layer (16 μm (5a)), an expansion nylon layer (25 μm (5b)), a low density polyethylene layer (30 μm (5c)) and an EVA sealant layer (40 μm (5d)).

The cover film 4 and the tear tape 5 are welded to each other (between 4b and 5a) into a toner seal member 1, and is welded to the main body 2 on the toner supply container by heat seal, similarly to

Embodiment 1.

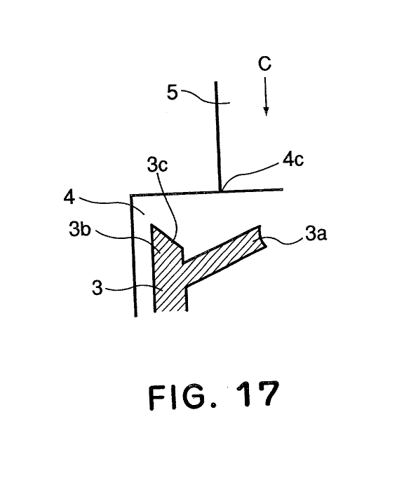

FIG. 17 is an enlarged view of a tearing start portion of the toner seal member.

Similarly to Embodiment 1, there is provided a rectilinear configuration 3c at the end portion of the extended seal portion 3b, and therefore, even the tearing start portion 4c portion is raised, and the force is produced in the peeling direction, the proper tearing can be assured. Thus, the cover film 4 can be assuredly torn. Furthermore, similarly to Embodiment 1, the rectilinear configuration 3c may be replaced with curve configuration such as an arcuation, and the similar advantageous effects can be provided.

As regards the assembling and manufacturing of the toner supply container, what is required is to weld the toner seal member on the main body 2 of the toner supply container. Therefore, the unsealing property stability can be accomplished with a very simple assembling.

Unsealing test has been carried out with the toner supply container of this embodiment, and it has been confirmed that unsealing strength is stably approx. 2-3 kg f, and tearing occurs with the intended width (the width of the tear tape). In addition, it has been confirmed that seal portion is not raised or peeled off.

The toner seal member of this embodiment can be applied to Embodiment 2, and in such a case, the assured unsealing property can be provided, and the delamination can be suppressed, similarly to Embodiment 2.

(Embodiment 4)

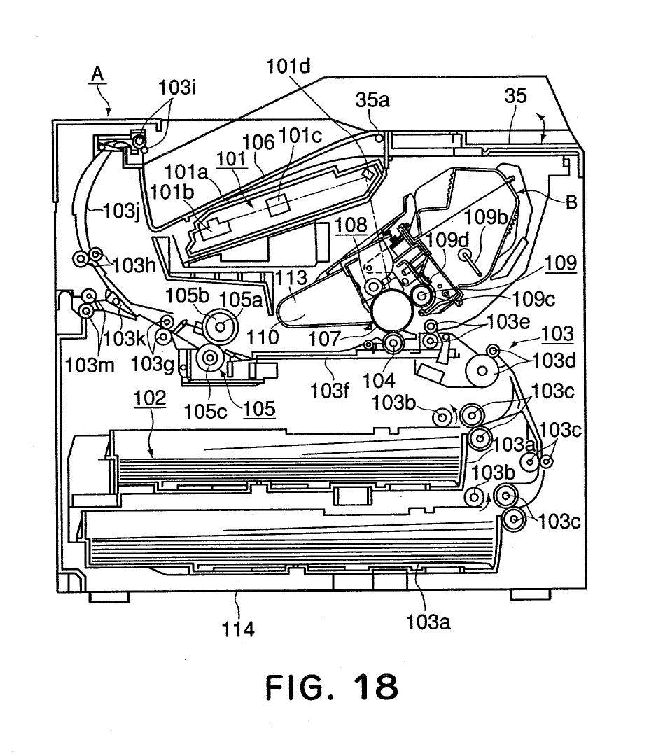

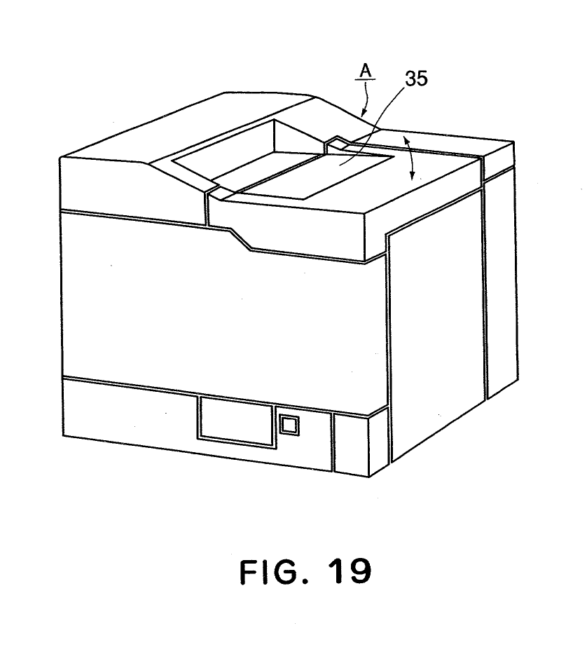

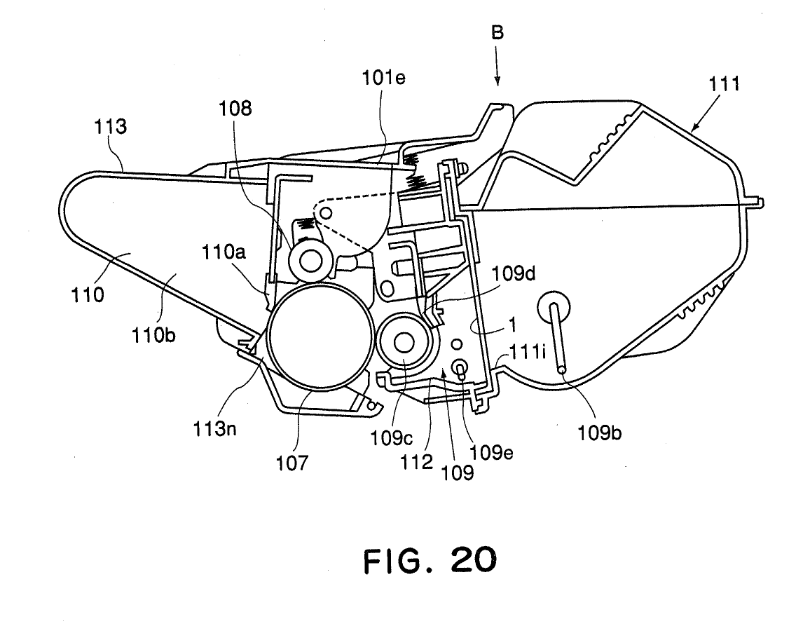

In this embodiment, the present invention, more particularly, the toner supply container of Embodiment 1 is used in a process cartridge. Referring to FIG. 20, the process cartridge of this embodiment will be described. FIG. 18 shows a general arrangement of an image forming apparatus in the form of a laser beam printer An using a process cartridge of this embodiment, and FIG. 19 shows an outer appearance. FIG. 20 is a sectional side elevation of a process cartridge B according to this embodiment of the present invention.

Referring first to FIG. 18, the laser beam printer A which is an example of the electrophotographic image forming apparatus. The laser beam printer A forms an image on a recording material 102 such as a recording paper, OHP sheet, textile or the like, through an electrophotographic image process. The laser beam printer A shown in FIG. 18 is loaded with a process cartridge B. The process cartridge B comprises an electrophotographic photosensitive member in the form of a drum (photosensitive drum 107), a charging roller 108 for electrically charging the photosensitive drum 107, and a developing means 109 for forming a toner image.

The photosensitive drum 107 is electrically charged by the charging roller 108, and is exposed to a laser beam modulated in accordance with image information and supplied from the optical means 101, so that latent image is formed corresponding to the image information on the photosensitive drum 107. The latent image is developed by the developing means 109 into a toner image. This time, the recording material 102 placed in a sheet feeding cassette 103a is picked up, reversed and fed in synchronism with the toner image, by a pick-up roller 103b, feeding rollers 103c, 103a and a pair of registration rollers 103e. The toner image formed on said photosensitive drum 107 is transferred onto the recording material 102 by the transferring means in the form of a transfer roller 104 supplied with a voltage. Thereafter, the recording material 102 now having the toner image transferred thereto is fed into fixing means 105 along a feeding guide 103c. The fixing means 105 comprises a driving roller 105c. and fixing roller 105b containing therein a heater 105a. The fixing means applies heat and pressure to the recording material 102 passing therethrough to fix the toner image thereon. The recording material 102 is fed by discharging rollers 103g, 103h, 1031 and, 103h, 1031, and is discharged to the discharging tray 106 along the reverse path 103j. The discharging tray 106 is provided on the top of the main assembly 114 of the laser beam printer A. By actuating a swingable flapper 103k, and the recording material 102 can be discharged directly by the discharging rollers 103m without the reverse path 103j. In this embodiment, the feeding means 103 is constituted by the pick-up roller 103b, the feeding rollers 103c, 103a, the registration rollers 103e, feeding guide 103c, the discharging rollers 103g, 103h, 1031, and discharging rollers 103m.

Referring to FIG. 20, the process cartridge B will be described. The process cartridge B comprises a toner frame 111 constituting the toner supply container for accommodating the toner, and a developing device frame 112 supporting the developing means 109 including a developing roller 109c. The toner frame 111 includes a toner discharging opening 1111, through which the toner is supplied into the developing device frame 112. The process cartridge B further comprising a cleaning frame 113 supporting the photosensitive drum 107, a cleaning means 110 including a cleaning blade 110a, and a charging roller 108. The cleaning frame 113 is coupled with the toner frame 111 and with the developing device frame 112. The process cartridge B can be detachably mountable to the main assembly 114 of the image forming apparatus by the user.

In the process cartridge B, the charging roller 108 (charging means) is contacted to the photosensitive drum 107, and is rotated by the photosensitive drum 107. During the image forming operation, the photosensitive drum 107 is rotated, and surface thereof is uniformly charged by the charging roller 108 supplied with a voltage. Then, a laser beam modulated in accordance with image information and supplied from optical means 101 provided in the laser beam printer An is projected onto the photosensitive drum 107 through an exposure opening 101e, so that electrostatic latent image is formed on the photosensitive drum 107. The latent image is visualized by developing the latent image by the developing means 109 with the toner. The optical means 101 include a laser diode 101a, a polygonal mirror 101b, a lens 101c and a reflection mirror 101d.

The developing means 109 supplies the toner to the developing portion toner of the photosensitive drum 107, by which the latent image formed on the photosensitive drum 107 is developed. The developing means 109 functions to supply the toner from the toner frame 111 onto the developing roller 109c through a toner discharging by rotation of a toner feeding member 109b. The developing roller 109c containing therein a fixed magnet is rotated, and a layer of the toner triboelectrically charged by the developing blade 109d is formed on the surface of the developing roller 109c, and the toner in the tonal layer is supplied to the developing zone of the photosensitive drum 107. The toner is transferred onto the photosensitive drum 107 responding to the latent image to form the toner visualized image.

The developing blade 109d functions to regulate the amount of the toner on the peripheral surface of the developing roller 109c and also to apply the triboelectric charge on the toner particles. Adjacent to the developing roller 109c, a toner stirring member 109e is rotatably supported to circulate the toner in the developing chamber.

The transfer roller 104 provided in the main assembly 114 of the apparatus is supplied with a voltage having a polarity which is the opposite to that of said toner image so that toner image is transferred from the photosensitive drum 107 onto the recording material 102. Thereafter, the residual toner is removed from the photosensitive drum 107 by the cleaning means 110. The cleaning means 110 scrapes the residual toner remaining on the photosensitive drum 107, by an elastic cleaning blade 110a contacted to the photosensitive drum 107 and collects the removed toner in a removed toner container 110b.

The process cartridge B is provided with an exposure opening 101e for projecting the light corresponding to the image information onto the photosensitive drum 107, and a transfer opening 113n for permitting the photosensitive drum 107 to face the recording material 102. More particularly, the exposure opening 101e is provided in the cleaning frame 113, and the transfer opening 113n is formed between the developing device frame 112 (developing portion) and the cleaning frame 113.

The toner frame 111 (toner accommodating portion) of such a process cartridge B has a toner seal member 1 which is any one of the above-described toner seal member to seal the toner discharging opening 1111, before the start of use of the process cartridge B. The toner frame 111 corresponds to the main body 2 of the toner supply container shown in FIG. 6, and the toner discharging opening 1111 corresponds to the toner discharging opening 2a. Therefore, the detailed description of sealing structure is omitted for simplicity. As shown in FIG. 20, before the start of use of the process cartridge B, the toner seal member 1 seals the toner discharging opening 1111 of the toner discharging to seal the toner frame 111 to prevent leakage of the toner-from inside. The toner seal member 1 is folded back from the sealing portion 1g, and the pulling portion 1h is overlaid on sealing portion 1g, and the free end thereof is extended to outside of the process cartridge B. Upon the start of use of the process cartridge B, the toner seal member 1 sealing the toner discharging opening 1111 is removed by pulling the pulling portion 1h. Then, the process cartridge B now having been unsealed is loaded into the laser beam printer A to permit developing operation.

Referring to FIG. 18, the mounting of the process cartridge B to the laser beam printer A will be described. An openable member 35 of the laser beam printer An is opened by rotation about a hinge 35a, guiding rails (unshown) which is provided on left and right inner walls of the main assembly 114 of apparatus and which extend downwardly toward the opening, are exposed. A cylindrical guide provided coaxially with the photosensitive drum 107 and an elongated orientation determination guide provided behind the cylindrical guide (unshown) are placed on the guiding rails, and the process cartridge is inserted until the cylindrical guide is engaged into the positioning groove of the main assembly 114 of the apparatus. When the process cartridge B is dismounted from the main assembly 114 of apparatus, the process cartridge B is drawn along the guiding rail through a reverse process.

According to this embodiment, the toner seal member 1 can be assuredly unsealed. Unsealing test has been carried out with the toner supply container of this embodiment, and it has been confirmed that unsealing strength is stably approx. 2-3 kg f, and tearing occurs at the intended portions. In addition, it has been confirmed that seal portion is not raised or peeled off.

In this embodiment, the toner supply container of Embodiment 1 is used. The same applied to the process cartridges using Embodiments 2 and 3.

### (Comparison example 1)

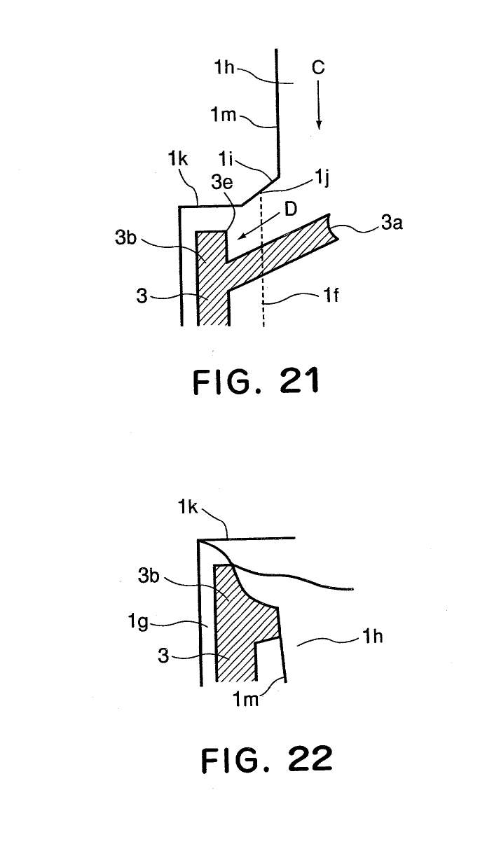

The sealing member of the comparison example is the same as the sealing member according to Embodiment 1 with the exception that be inclined rectilinear configuration portion 3c is not provided in the extended seal portion 3b of the seal portion 3. FIG. 21 shows the structure of the sealing member of the comparison example. When the toner seal member 1 is removed, the edge portion 1j which is the tearing start portion is raised similarly to Embodiment 1, and the force D is applied to the extended seal portion 3b in the peeling direction. The force is concentrated on the inner apex 3e at the edge of the extended portion 3b. Therefore, the force is not received at a line, and therefore, the bonding strength is not enough.

The unsealing tests were carried out with the toner supply container of this example. Unsealing test has been carried out with the toner supply container of this embodiment, and it has been confirmed that unsealing strength is stably approx. 2-3 kg f, and tearing occurs at the intended portions. In addition, it has been confirmed that seal portion is not raised or peeled off.

However, when the bonding strength of the extended seal portion 3b is low due to insufficient adjustment of the contact between the container seal surface and the sealing jig because of variations in the molding of the main body 2 of the toner supply container, the toner seal is not torn at the intended tearing portions 1f with the result that extended seal portion 3b is torn at the inner apex 3e at the edge (FIG. 22), and the unsealing strength (resistance) increases to approx. 5-6 kg f, in some-cases. Furthermore, the sealing portion 1g of the toner seal was completely peeled off, and the sealing member clogs in the toner seal pulling opening (unshown), in some cases.

In the foregoing, the electrophotographic image forming apparatus is an apparatus for forming an image on a recording material through an electrophotographic image formation process. Examples of electrophotographic image forming apparatuses, include an electrophotographic copying machine, an electrophotographic printer (laser beam printer, LED printer or the like), a facsimile machine, a word processor and the like.

The process cartridge is a cartridge which contains an electrophotographic photosensitive member and at least one of charging means, developing means and cleaning means as a unit and which is detachably mountable to the main assembly of the image forming apparatus.

As described in the foregoing, according to the embodiments of the present invention, the following advantageous effects are provided. In the tearing removal of the sealing member from the toner supply container or the process cartridge, the side portions of the portion to be removed are prevented from feeling of the toner supply container or the process cartridge upon the start of tearing removal operation. Therefore, the sealing member removal is stabilized. The peeling of the surface layer portion of the sealing member is prevented from expanding, by which the removal of the sealing member is stabilized.

In the assembling and manufacturing of the toner supply container and process cartridge, the number of manufacturing steps does not increase, and stability of the unsealing property of the toner seal is accomplished with very simple assembling.

While the invention has been described with reference to the structures disclosed herein, it is not confined to the details set forth and this application is intended to cover such modifications or changes as may come within the purpose of the improvements or the scope of the following claims.

What is claimed is:

1. A toner supply container detachably mountable to an image forming apparatus, comprising:
a main body, provided with an opening for permitting discharge of the toner, for accommodating the toner;
a sealing member for unsealably sealing the opening;
wherein the opening is unsealed by tearing a part of said sealing member,
wherein a pattern of welding with which said sealing member is welded on the main body of the container is inclined inwardly with respect to a tearing direction at a laterally outward end portion at a tearing starting side portion.

2. A toner supply container according to claim 1, wherein the welding pattern is inclined rectilinearly.

3. A toner supply container according to claim 1, wherein said wielding pattern is inclined with curvature.

4. A toner supply container according to claim 1, wherein the welding pattern is cut-away toward downstream with respect to the tearing direction, at a portion where the tearing starts in a welded portion.

5. A toner supply container according to claim 1, wherein said sealing member has a seal portion welded to the main body of said container, and a sealing member pulling portion extended and folded back therefrom.

6. A toner supply container according to claim 1, wherein said sealing member is provided with a tearing guide portion provided by laser irradiation.

7. A toner supply container according to claim 1, wherein said sealing member has a cover film sealing the opening and a tear tape for tearing the cover film.

8. A process cartridge detachably mountable to an image forming apparatus, comprising:
a developing portion, having a photosensitive member, for developing a latent image on the photosensitive member;
a toner accommodating portion for accommodating toner to said developing portion, said toner accommodating portion is provided with an opening for permitting discharging of tile toner;
a sealing member for unsealably sealing the opening, wherein said sealing member has a seal portion welded to the main body of said container, and a sealing member pulling portion extended and folded back therefrom.
wherein the opening is unsealed by tearing a part of said sealing member,
wherein wherein a pattern of welding with which said sealing member is welded on the main body of the container is inclined inwardly with respect to a tearing direction at a laterally outward end portion at a tearing starting side end portion.

9. A toner supply container according to claim 8, wherein the welding pattern is inclined rectilinearly.

10. A toner supply container according to claim 8, wherein said welding pattern is inclined with curvature.

11. A toner supply container according to claim 8, wherein the welding pattern is cut-away toward downstream with respect to the tearing direction, at a portion where the tearing starts in a welded portion.

12. A toner supply container according to claim 8, wherein said sealing member is provided with a tearing guide portion provided by laser irradiation.

13. A toner supply container according to claim 8, wherein said sealing member has a cover film sealing the opening and a tear tape for tearing the cover film.
